(19) United States
(12) Patent Application Publication
(10) Pub. No.: US 2018/0007627 A1
(43) Pub. Date: Jan. 4, 2018

(54) MODIFIED UF-OFDM FOR ENHANCED WI-FI IOT UL TRANSMISSION

(71) Applicant: Intel Corporation, Santa Clara, CA (US)

(72) Inventors: Shahrnaz AZIZI, Cupertino, CA (US); Thomas J. KENNEY, Portland, OR (US); Eldad PERAHIA, Portland, OR (US)

(21) Appl. No.: 15/196,349

(22) Filed: Jun. 29, 2016

(51) Int. Cl. H04W 52/02; H04L 27/26

(52) U.S. Cl. CPC H04W 52/029; H04L 27/2666; H04L 27/265; H04L 27/2607; H04L 27/2614; H04L 27/2634

(57) ABSTRACT

The devices and methods herein can produce a new waveform for transmission that is robust to carrier frequency offset (CFO) errors, and hence, enables implementation of low cost and low power consumption local oscillators at the Internet of Things (IoT) devices. The proposed method builds upon the existing 802.11ax OFDMA architecture, and adds block filtering to each resource unit to reduce out of band (OOB) emissions. Embodiments also define a modified Universal Filtered OFDM (UF-OFDM) technique that adds a Guard Interval (GI) to UF-OFDM, and thus, provides a GI-UF-OFDM architecture. The added GI helps prevent inter-symbol interference (ISI) at the receiver.

### TECHNICAL FIELD

Embodiments described herein generally relate to wireless communications between devices in wireless networks. Some embodiments relate to a wireless network communicating using Wireless Local Area Networks (WLAN). Some embodiments relate to wireless networks that operate in accordance with one of the Institute of Electrical and Electronics Engineers (IEEE) 802.11 standards including the IEEE 802.11-WLAN standards including IEEE 802.11ax. Some embodiments relate to uplink waveforms. Some embodiments relate to providing guard intervals in conjunction with filtering uplink transmissions.

### BACKGROUND

The Internet of Things (IoT) is a network of devices, structures, appliances, etc. that include electronics that provide information about the state of different objects or various environments. IoT sensors can be deployed in areas where replacement of the sensors is impractical (e.g., inside air conditioning vents, in walls, inside engines, etc.). To use these sensors in these locations, the IoT devices must have a long service life, which usually means long battery life. The communication system of the IoT devices is generally the greediest user of battery power. IoT sensors typically use a wireless communication media for communication. Thus, to deploy IoT devices into areas where the device is not replaceable, changes to the wireless communication system need to be made to ensure longer battery life.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an embodiment of a communication environment including one or more access points and one or more stations;

FIG. 2A is a block diagram of the transmit side of a station;

FIG. 2B is a block diagram of the receive side of a station or access point;

FIG. 3A is a signal or waveform diagram illustrating an embodiment of a universal-filtered orthogonal frequency-division multiplexing (UF-OFDM) transmit signal;

FIG. 3B is a signal or waveform diagram illustrating an embodiment of a universal-filtered orthogonal frequency-division multiplexing (UF-OFDM) signal as received at a station or access point;

FIG. 4A is a signal or waveform diagram illustrating an embodiment of a guard interval universal-filtered orthogonal frequency-division multiplexing (GI-UF-OFDM) transmit signal;

FIG. 4B is a signal or waveform diagram illustrating an embodiment of a guard interval universal-filtered orthogonal frequency-division multiplexing (GI-UF-OFDM) signal as received at a station or access point;

FIG. 5 is a flowchart illustrating an embodiment of a method for transmitting a signal that includes a guard interval and is filtered;

FIG. 6 is a flowchart illustrating an embodiment of a method for receiving a signal that includes a guard interval and is filtered;

FIG. 7 is a block diagram illustrating components of a STA and/or AP.

### DESCRIPTION OF EMBODIMENTS

Embodiments herein are generally directed to wireless communications systems. Various embodiments are directed to wireless communications performed according to one or more wireless communications standards. Some embodiments may involve wireless communications performed according to High-Efficiency Wi-Fi standards developed by the IEEE 802.11ax Study Group. Various embodiments may involve wireless communications performed in accordance with an IEEE 802.11ax or other standard, whether adopted or proposed.

Some embodiments may additionally or alternatively involve wireless communications according to one or more other wireless communication standards. Examples of other wireless communications technologies and/or standards that may be used in various embodiments may include—without limitation—other IEEE wireless communication standards, such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, and/or IEEE 802.11ay standards, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

There has been a considerable interest in enabling Wi-Fi for IoT, as other wireless technologies are often used for IoT devices. Many IoT devices require a substantially long battery life (e.g. 5 years or more). Besides battery life, the IoT sensors and IoT devices have to be low cost. One approach to reduce cost from current Wi-Fi devices is to define a new narrow bandwidth operation. The recent 802.11ax amendment defines an OFDM Access (OFDMA) multiplexing technique with sub-channels as small as 2 MHz. If new IOT devices can operate with a narrow bandwidth (NB) based on 802.11ax OFDMA allocations, the IoT device may achieve the lower power/longer battery life objective and remain low cost.

There is no guard band defined between each of the 802.11ax OFDMA resource allocations, and thus, frequency synchronization of uplink (UL) NB devices is crucial. However, maintaining synchronization for the IoT sensor type devices is problematic, since it requires accurate local oscillators, which require higher power consumption and cost more. Hence, there are two intertwined problems to be solved: 1) power consumption and 2) frequency synchronization, in particular UL frequency synchronization.

At the downlink (DL) receiver in the IoT devices, a low power wake up radio (LP-WUR) can be implemented to avoid periodic monitoring of an incoming packet to reduce power consumption. In DL, synchronization is limited to the pair of access point and the receiving station, and the synchronization among stations does not matter. Defining stringent oscillator accuracy for the AP device usually provides a good remedy.

The need for accurate frequency synchronization is more dominant in the uplink transmission since the transmitted signal from different unsynchronized devices can generate considerable inter-carrier interference (ICI) among adjacent transmissions. An objective of the embodiments described herein is to create a new waveform which allows the requirement on UL frequency synchronization to be relaxed, and thus, IoT devices can use less expensive and lower-power consuming oscillators.

The approach here is to define a new waveform for IoT uplink transmission that is robust to carrier frequency offset (CFO) errors, and hence, enables implementation of low cost and low power consumption local oscillators at the IoT device or IoT sensor. The proposed method builds upon the existing 802.11ax OFDMA architecture, and adds block filtering to each resource unit to reduce out of band (OOB) emission. Embodiments define a modified Universal Filtered OFDM (UF-OFDM) technique that adds a Guard Interval (GI) to UF-OFDM, and thus, provides a GI-UF-OFDM architecture.

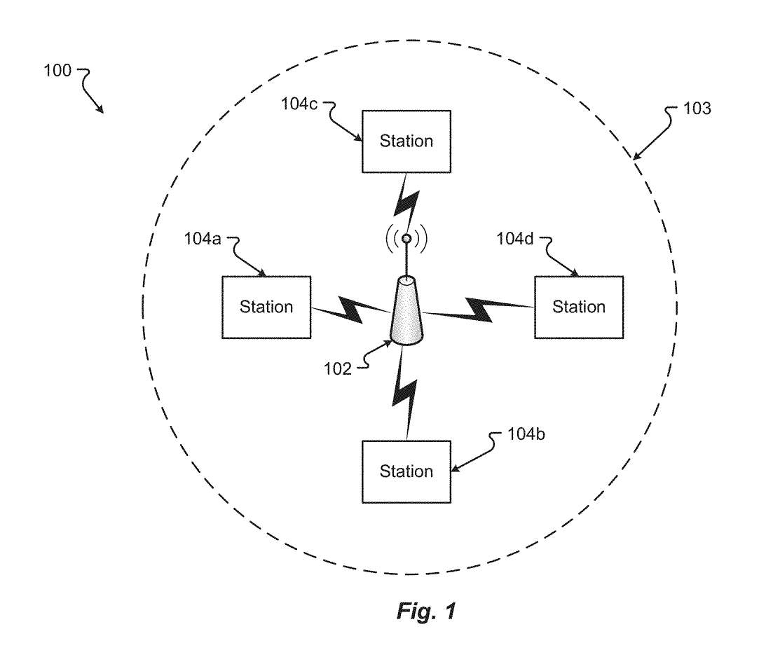

FIG. 1 illustrates an example of an operating environment 100 such as may be representative of various embodiments. The WLAN may comprise a basic service set (BSS) 100 that may include a master station 102 and one or more stations (STAs) 104. The master station 102 may be an access point (AP) using the IEEE 802.11 protocol(s) to transmit and receive. Hereinafter, the term AP will be used to identify the master station 102 but the embodiments may not be limited to the AP performing the functions described herein as any other capable station may also perform the functions. The AP 102 may be a base station and may use other communications protocols as well as the IEEE 802.11 protocol. The IEEE 802.11 protocol may be IEEE 802.11ax or later standard. The IEEE 802.11 protocol may include using OFDMA, time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The STAs 104 can represent IoT devices. The STAs 104 may include one or more high-efficiency wireless (HEW) (as illustrated in, e.g., the IEEE 802.11ax standard) STAs and/or one or more legacy (as illustrated in, e.g., the IEEE 802.11n/ac standards) STAs. The legacy STAs may operate in accordance with one or more of IEEE 802.11 a/b/g/n/ac/ad/af/ah/aj, or another legacy wireless communication standard. The HEW STAs 104 may be wireless transmit and receive devices, for example, a cellular telephone, a smart telephone, a handheld wireless device, wireless glasses, a wireless watch, a wireless personal device, a tablet, IoT sensors, or another device that may be transmitting and receiving using a IEEE 802.11 protocol, for example, the IEEE 802.11ax or another wireless protocol. In the operating environment 100, an AP 102 may generally manage access to the wireless medium in the WLAN 103.

Within the environment 100, one or more STAs 104a, 104b, 104c, 104d may associate and/or communicate with the AP 102 to join the WLAN 103. Joining the WLAN 103 may enable STAs 104a-104d to wirelessly communicate with each other via AP 102, with each other directly (e.g., from STA 104a to STA 104b, 104c, and/or 104d), with the AP 102, or to another network or resource through the AP 102. In some configurations, to send data to a recipient (e.g., STA 104a), a sending STA (e.g., STA 104b) may transmit an UL physical layer convergence procedure (PLCP) protocol data unit (PPDU) comprising the data, to AP 102, which may then send the data to the recipient STA 104a, in a downlink (DL) PPDU. In other configurations, the sending STA (e.g., STA 104b) may transmit an UL physical layer convergence procedure (PLCP) protocol data unit (PPDU) comprising the data to the recipient STA 104a as a downlink (DL) PPDU. The PLCP is the physical layer protocol that is used with 802.11 and other standards.

In some configurations, a frame of data transmitted between the STAs 104 or between a STA 104 and the AP 102 may be configurable. For example, a channel used for communication may be divided into subchannels that may be 20 MHz, 40 MHz, or 80 MHz, 160 MHz, 320 MHz of contiguous bandwidth or an 80+80 MHz (160 MHz) of non-contiguous bandwidth. Further, the bandwidth of a subchannel may be incremented into 1 MHz, 1.25 MHz, 2.03 MHz, 2.5 MHz, 5 MHz and 10 MHz bandwidths, or a combination thereof, or another bandwidth division that is less or equal to the available bandwidth may also be used. The bandwidth of the subchannels may be based on a number of active subcarriers. The bandwidth of the subchannels can be multiples of 26 (e.g., 26, 52, 104, etc.) active subcarriers or may be tones, which are spaced by 20 MHz, for example 26 tones, 52 tones, 106 tones, 242 tones, etc. In some configurations, the bandwidth of the subchannels is 256 tones spaced by 20 MHz. In other configurations, the subchannels are a multiple of 26 tones or a multiple of 20 MHz. A 20 MHz subchannel may also comprise 256 tones for use with a 256 point Fast Fourier Transform (FFT).

When managing access to the wireless medium in the WLAN 103, the AP 102 may schedule medium access, for the sending STA 104b, during an uplink (UL) time interval, during which the AP 102 may refrain from transmitting over the wireless medium. The UL time interval may comprise a portion of a transmit opportunity (TXOP) owned by AP 102.

At a given point in time, multiple STAs (e.g., 104b and 104c), in the WLAN 103, may wish to send data. In some configurations, rather than scheduling medium access for STAs 104b and 104c in different respective UL time intervals, the AP 102 may schedule medium access for STAs 104b and 104c to support UL multiple user (MU) transmission techniques, according to which multiple STAs 104b and 104c may transmit UL MU Physical Layer Convergence Protocol (PLCP) Protocol Data Units (PPDUs) to the AP 102 simultaneously during a given UL time interval. For example, by using UL MU orthogonal frequency division multiplexing access (OFDMA) techniques during a given UL time interval, multiple STAs 104b and 104c may transmit UL MU PPDUs to the AP 102 via different respective OFDMA resource units (RUs) allocated by the AP 102. In another example, by using UL MU multiple-input multiple-output (MU-MIMO) techniques during a given UL time interval, multiple STAs 104b and 104c may transmit UL MU PPDUs to the AP 102 via different respective spatial streams allocated by the AP 102.

To manage access, the AP 102 may transmit a HEW master-sync transmission, which may be a trigger frame (TF) or a control and schedule transmission, at the beginning of the control period. The AP 102 may transmit a time duration of the TXOP and sub-channel information. During the HEW control period, HEW STAs 104 may communicate with the AP 102 in accordance with a non-contention based multiple access technique, such as OFDMA or MU-MIMO.

During the HEW master-sync transmission, the STAs 104 may contend for the wireless medium with the legacy devices 106 being excluded from contending for the wireless medium during the HEW master-sync transmission. The TF used during this HEW master-sync transmission may indicate an UL-MU-MIMO and/or UL OFDMA control period. The multiple-access technique used during the control period may be a scheduled OFDMA technique, or alternatively, may be a TDMA technique, a frequency division multiple access (FDMA) technique, or a SDMA technique.

The AP 102 may also communicate with legacy stations and/or HEW stations 104 in accordance with legacy IEEE 802.11 communication techniques. In some configurations, the AP 102 may also be configurable to communicate with HEW stations 104 outside the HEW control period in accordance with legacy IEEE 802.11 communication techniques, although this is not a requirement.

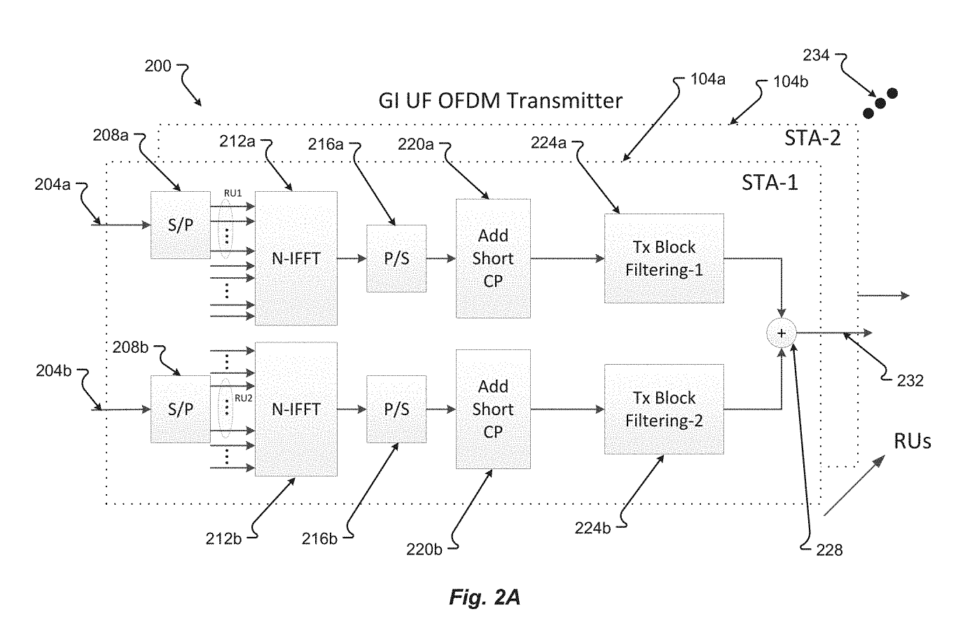

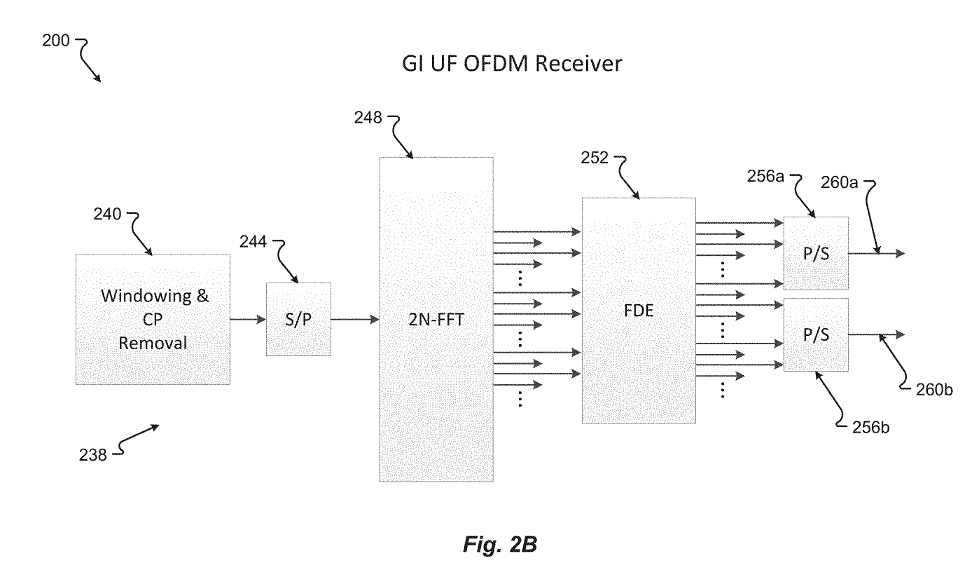

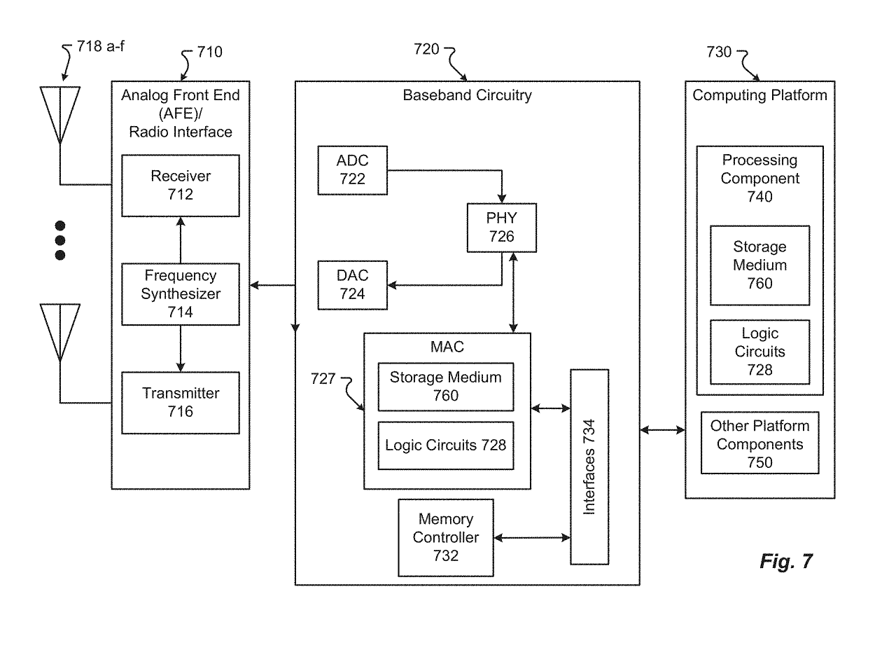

An embodiment of an UL transmitter 200, possibly similar to the transmitter 718 described in conjunction with FIG. 7, is shown in FIG. 2A. As mentioned above, an objective of the proposed method is to decrease the OOB emission of OFDMA transmission to reduce the receiver's sensitivity to time and frequency inaccuracy. This objective is achieved by applying a defined filter to a group of consecutive subcarriers that form the smallest 802.11ax OFDMA RU. The proposed technique has the advantage of significantly reducing the effect of sidelobe interference on the immediate adjacent RUs.

The block diagram in FIG. 2A shows a general case where more than one RU (contiguous or non-contiguous) is assigned to a station for uplink transmission. We note that the current 802.11ax specification may only allow the allocation of one RU to a station (e.g., a 26-tone RU, a 52-tone RU, a 106-tone RU, etc.). However, as mentioned above, there is considerable interest in enabling IoT devices that operate only in a narrow bandwidth mode. Therefore, it is envisioned that these IoT devices can use a 26-tone or a 52-tone allocation. The 52-tone allocation can be considered two 26-tone allocations for the purpose of block transmit (tx)-filtering.

An UL environment 200 can include two or more stations 104a, 104b, as shown in FIG. 2A. However, there may be more or fewer stations 104 in the environment, as represented by ellipses 234. Each station 104 may be associated with an RU (i.e., specific narrowband UL bandwidth), as explained above. Each station can include one or more GI UF OFDM transmitters. The GI UF OFDM transmitter can receive an input signal 204 representing data to be transmitted from the STA 104 to another STA 104 or to the AP 102 or data to be transmitted from AP 102 to STA's 104. Embodiments of the GI UF OFDM transmitter can be hardware and/or software. In some configurations, the GI UF OFDM transmitter is a system on chip (SOC) or similar hardware component.

The input signal 204 may be received by a serial-to-parallel converter (S/P) 208, also referred to as a de-serializer. The S/P 208 converts the serial input signal 204 into two or more parallel signals that are presented to an Inverse Fast Fourier Transform (IFFT) 212. There are N parallel signals input into the N-IFFT 212.

The N-IFFT 212 can convert the parallel input signals from the frequency domain into the time domain. In other words, the N-IFFT 212 computes the inverse of the discrete Fourier transform (DFT) for the sequence of N parallel input signals. The output of the N-IFFT 212, now in the time domain, is then presented to a parallel-to-serial converter (P/S) 216, which serializes the output of the N-IFFT 212.

For each symbol presented from the P/S 216, a guard interval (GI) is placed on the symbol by the “Add Short cyclic prefix” (CP) component 220, which will be referred to as the CP adder 220. A CP is a set of samples from the end of the symbol that are added or prefixed to the beginning of the symbol. The CP forms the guard interval. The CP has enough samples to ensure that timing errors due to the lack of perfect timing synchronizations between STA's 104 do not lead to corrupted data in the symbol when the symbol is received by the receiver. The transformation to the time domain by the IFFT 212 is required to add the CP onto the symbol. The added CP reduces or eliminates ISI between symbols transmitted by the STA 104.

After the CP adder 220 passes the new waveform, the Tx Block filter 224 can filter the signal to eliminate any side lobes from the signal. The Tx Block filter 224 can be any band pass filter tuned to the frequency of the RU associated with the STA 104. Thus, the Tx Block filter 224 ensures that the out of band (OoB) leakage is reduced or eliminated at the receiver. The Tx Block filter 224 can be a finite pulse response (FIR) filter or the like.

In some configurations, the components 208a-224a are associated with one RU, while the components 208b-224b are associated with a different, second RU. In an alternative configuration, the components 208a-224a are associated with a first set of 26 tones of a first 52-tone RU, while the components 208b-224b are associated with a second set of 26 tones of the same 52-tone RU. Regardless, a mixer 228 can receive the signals from the two sets of components 208a-224a and 208b-224b and mix the signals for transmission to another STA 104 or the AP 102.

The receiver side of the UL environment 200 can be as shown in FIG. 2B. include two or more stations 104a, 104b. The receiver side can include a GI UF OFDM receiver. Embodiments of the GI UF OFDM receiver can be hardware and/or software. In some configurations, the GI UF OFDM receiver is a SOC or similar hardware component.

The GI UF OFDM receiver can receive an input signal at a windowing and CP removal component 240. The input signal may be the filtered signal transmitted from the STA 104. The windowing and CP removal component 240 can apply a window function (i.e., zero out values not within the interval for receiving the symbol) to the input signal to isolate the symbol in the received signal. Then, the CP prefixed to the symbol can be determined, located and removed by the windowing and CP removal component 240. At this juncture, the received symbol may be processed by other components.

The input symbol may be received by a serial-to-parallel converter (S/P) 244, also referred to as a deserializer. The S/P 244, similar to S/P 208, converts the serial input signal 204 into two or more parallel signals that are presented to an 2N-Fast Fourier Transform (2N-FFT) 248. There are 2N parallel signals input into the 2N-FFT 248.

The 2N-FFT 248 can convert the parallel input signals from the time domain into the frequency domain. In other words, the 2N-FFT 248 computes the discrete DFT for the sequence of parallel input signals. The output of the 2N-FFT 248, now in the frequency domain, is then presented to a Frequency Domain Equalization component (FDE) 252 for further signal processing. The FDE 252 can extract per carrier signals for presentation to two or more parallel-to-serial converters (P/S) 256 such that multipath fading is mitigated, which serializes the output of the N-IFFT 212.

The CP added to the input signal of the receiver helps reduce or eliminate ISI, while the Tx Block filter 224 ensures that the out of band (OoB) leakage is reduced or eliminated at the receiver. The GI UF OFDM transmitter and GI UF OFDM receiver have several advantages. The designs provide for efficient implementation using FFT/IFFT. The GI UF OFDM transmitter and GI UF OFDM receiver allow for flexible spectrum allocation to different users and more-easily implemented application of multiple input/multiple output (MIMO) technology. Further, the GI UF OFDM transmitter and GI UF OFDM receiver allow for flexible signal and data multiplexing, e.g., placement of pilot across the frequency-time grid for channel estimation and provide for simple FDE implementation for multipath fading mitigation.

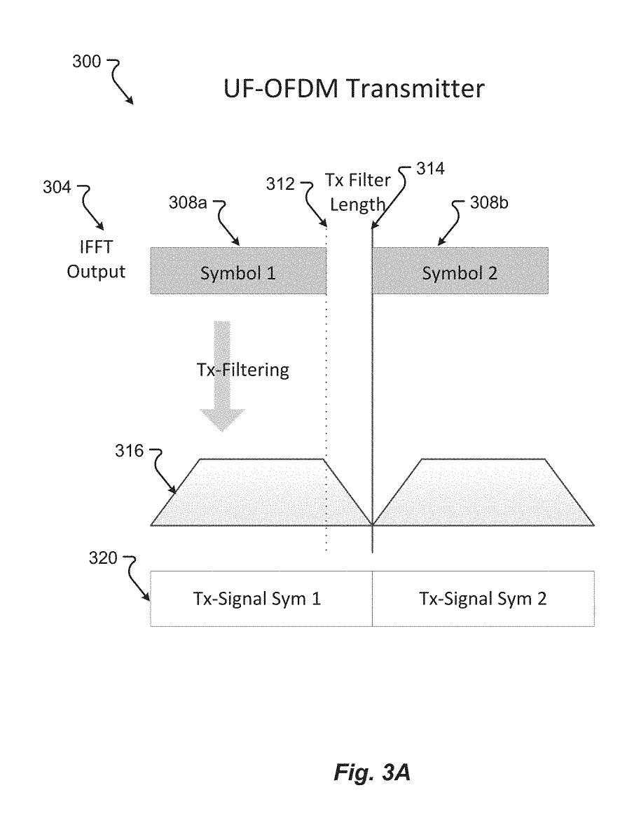

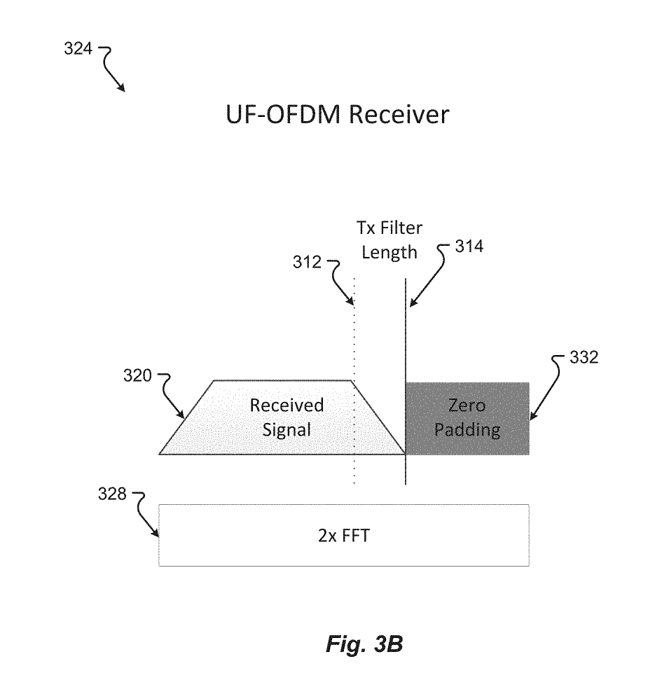

A transmitted UF OFDM signal waveform may be as shown in FIG. 3A. While UF-OFDM reduces the OOB emissions, UF OFDM performance degrades in multipath channel environments since the waveform lacks a cyclic prefix. The waveform 300 shown in FIG. 3A may be produced by a UF-OFDM transmitter. The IFFT output 304 from an IFFT, similar to IFFT 212, may include a symbol 308. The symbol 308 is filtered by a Tx filter, similar to Tx Block Filter 224. The filtered signal 316 may stretch over a transmit filter length, where the signal is filtered before the transmission of a new symbol 308b, represented by line 314. may represent the transmitted signal 320. The entire transmit signal length is represented by box 320. The filtering may be applied across multiple carrier. The filtering decreases or eliminates sidelobe interference on adjacent subchannels and offers reduced intercarrier interference (ICI)

The waveform 320, as received by the UF-OFDM receiver 324, is shown in FIG. 3B. The waveform 320 may include zero padding 332 generated by the windowing function 240. The signal with the padding, represented by block 328, may be sent to the 2×-FFT 248 for conversion to the frequency domain and processing by the FDE 252. As shown in FIGS. 3A and 3B, the UF-OFDM signal does not include a guard interval.

The transmission of data may be based on the reception of a TF, but the transmitted signal may not be perfectly timed and incur impairments. A guard interval prevents ISI in such an environment.

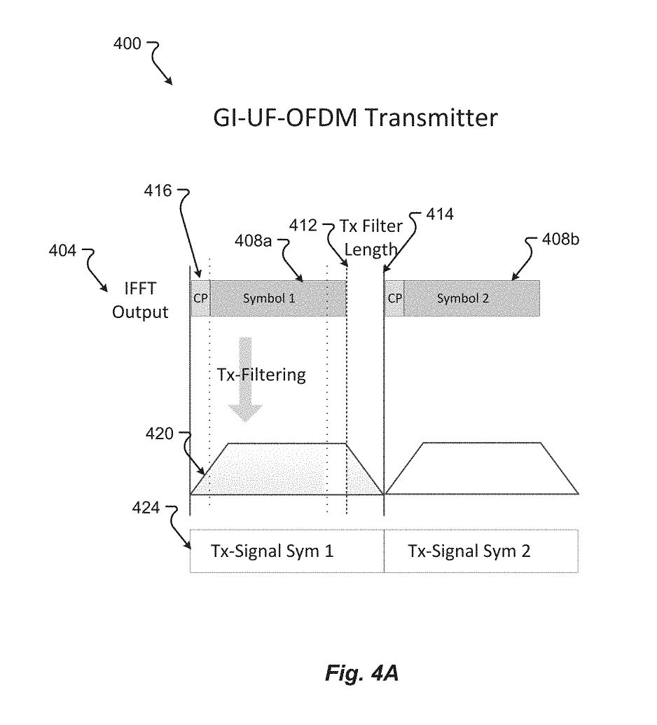

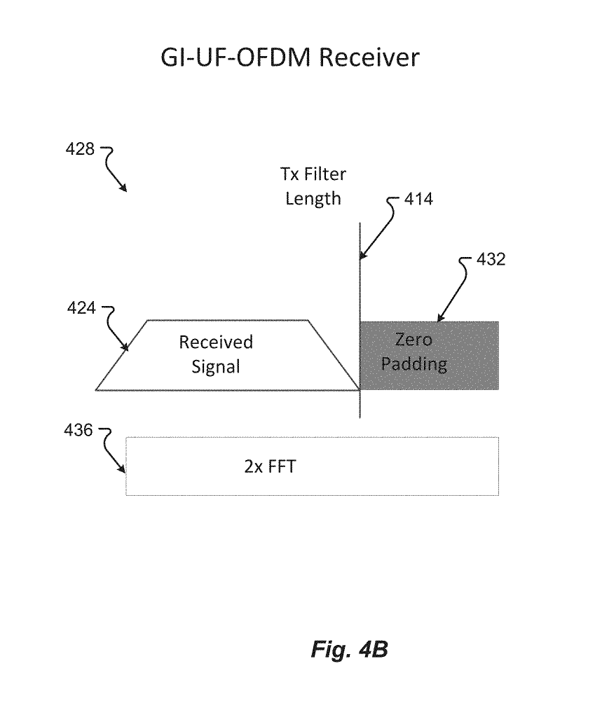

FIGS. 4A and 4B show a new waveform including CP that functions as a guard interval. The symbol 408 is the same or similar to symbol 308 received as an output from the IFFT 404. CP 416 is prefixed to the symbol 408. The overall symbol length is increased due to the addition of the CP 416. Thus, the filtered signal stretches from the end of symbol 408a, represented by line 412 to the beginning of the new symbol 408b transmission, represented by line 414. The filtered signal 420 may be represented by box 424 which is larger than box 320 shown in FIG. 3A.

The waveform 424, as received by the UF-OFDM receiver side 428, is shown in FIG. 4B. The waveform 424 may include zero padding 432 generated by the windowing function 240. The signal with the padding, represented by block 436, may be sent to the 2×-FFT 248 for conversion to the frequency domain and processing by the FDE 252. As shown in FIGS. 4A and 4B, the GI-UF-OFDM signal does include a guard interval.

The newly created waveform is based on UF-OFDM and applies to the 802.11ax uplink sub-channels (resource units) to reduce the OOB emission from each allocation. However, the CP 416 forms a short guard interval, which is also added to later be discarded at the AP receiver to avoid inter-symbol interference incurred by a multipath channel. The method of forming the waveform shown in FIGS. 4A and 4B assumes that UL transmissions are trigger based and that UL transmissions are time synchronized relative to the receive time of the trigger frame. In addition, the method assumes devices can adjust timing based on prior estimate(s) of round-trip delays. Hence, the focus is to relax the requirement on CFO, and introduce a Guard Interval (GI) to combat delay spread. The proposal defines the block filtering of UF-OFDM to specifically match the 802.11ax Resource Unit (RU) sizes for easy inclusion and integration with the existing 802.11ax architecture.

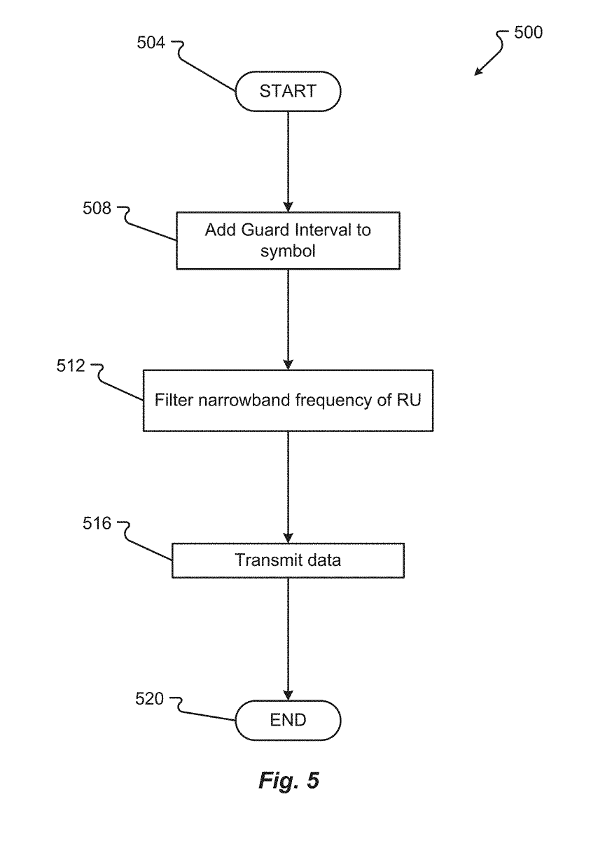

A method 500 for producing the GI-UF-OFDM waveform is shown in FIG. 5. A general order for the steps of the method 500 is shown in FIG. 5. Generally, the method 500 starts with a start operation 504 and ends with an end operation 520. The method 500 can include more or fewer steps or can arrange the order of the steps differently than those shown in FIG. 5. The method 500 can be executed as a set of computer-executable instructions executed by a computer system and encoded or stored on a computer readable medium. In other configurations, the method 500 may be executed in hardware, for example, by gates in a Field Programmable Gate Array (FPGA), an Application Specific Integrated Circuit, a system on chip (SOC), or the like. Hereinafter, the method 500 shall be explained with reference to the systems, hardware components, modules, software, signals, data structures, etc. described in conjunction with FIGS. 1-4A.

A guard interval 416 is added to a symbol 408, in step 508. A CP adder 220a can add a CP (i.e., the guard interval) to a signal provided by a P/S 216. The CP 416 is prefixed to the symbol 408 to create a waveform that may then be filtered.

A Tx Block Filter 224 may then filter the waveform provided by the CP adder, in step 512. The Tx Block Filter 224 can be a narrow bandpass filter that is based on the frequency of the RU associated with the or assigned to the STA 104. The filter eliminates or reduces sidelobes associated with the generated signal of the STA 104. A stretched signal length allows for transmission of the symbol and CP, thus creating signal 420.

The filtered signal 420 may then be transmitted, in step 516. The filtered signal may be mixed with one or more other signals by mixer 228 and then sent as output signal 232 to the receiver. The transmission of the signal 420 may be as described in conjunction with FIG. 7.

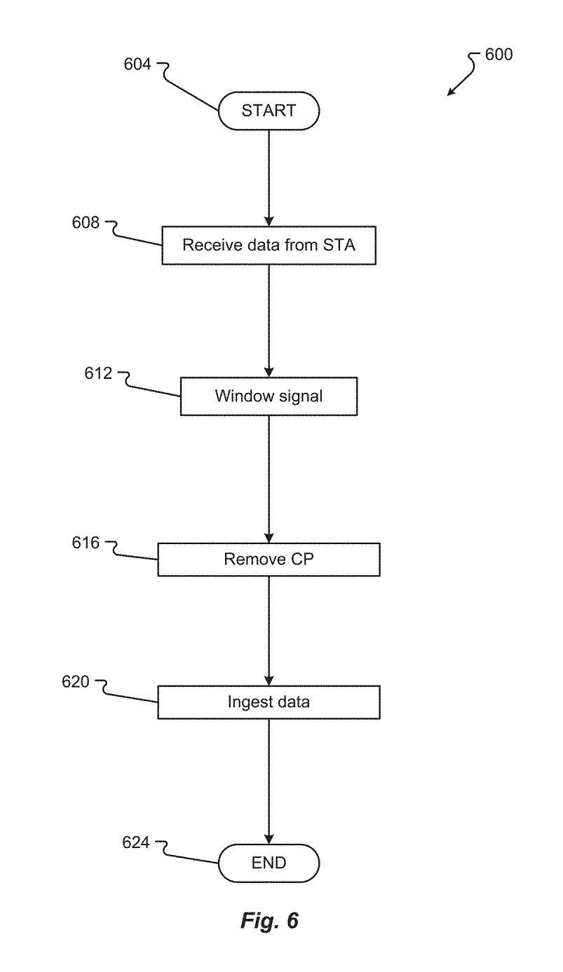

A method 600 for receiving and/or processing the GI-UF-OFDM waveform at a receiver 238 may be as shown in FIG. 6. A general order for the steps of the method 600 is shown in FIG. 6. Generally, the method 600 starts with a start operation 604 and ends with an end operation 624. The method 600 can include more or fewer steps or can arrange the order of the steps differently than those shown in FIG. 6. The method 600 can be executed as a set of computer-executable instructions executed by a computer system and encoded or stored on a computer readable medium. In other configurations, the method 500 may be executed in hardware, for example, by gates in a Field Programmable Gate Array (FPGA), an Application Specific Integrated Circuit, a system on chip (SOC), or the like. Hereinafter, the method 600 shall be explained with reference to the systems, hardware components, modules, software, signals, data structures, etc. described in conjunction with FIGS. 1-5.

The receiver 238 can receive the incoming signal 420 from a STA 104, in step 608. The reception of the signal 420 may be as described in conjunction with FIG. 7.

Before or after isolating the signal by windowing, the windowing and CP removal component 240 can then remove the CP or guard interval 416, in step 616. A guard interval 416 was added to a symbol 408, in step 502 described in conjunction with FIG. 5. the windowing and CP removal component 240 can determine then remove the CP 416 (i.e., the guard interval) to isolate the symbol 408 in the signal 424. Then, further processing on the symbol is possible.

A windowing and CP removal component 240 may then window the signal 420, in step 612. The receiver can pad the signal with zero samples 432 following the received signal 424, which includes the symbol 408 and the CP 416.

Further components can “ingest” the data, in step 620. Ingesting the data can refer to any processing to provide the data to a subsequent component or process. For example, a S/P 244 can convert the serial symbol data to parallel for provision to a 2×-FFT 248, which converts symbol sequences from the time domain to the frequency domain. A FDE 252 may equalize carrier data within the converted symbol data and provide that data to a P/S that serializes the data.

FIG. 7 illustrates an embodiment of a communications device 700 that may implement one or more of AP 102 and STAs 104a-104d of FIG. 1. In various embodiments, device 700 may comprise a logic circuit 728. The logic circuit 728 may include physical circuits to perform operations described for one or more of AP 102 and STAs 104a-104d of FIG. 1, for example. As shown in FIG. 7, device 700 may include one or more of, but is not limited to, a radio interface 710, baseband circuitry 720, and/or computing platform 730.

The device 700 may implement some or all of the structure and/or operations for one or more of AP 102 and STAs 104a-104d of FIG. 1, storage medium 760, and logic circuit 728 in a single computing entity, such as entirely within a single device. Alternatively, the device 700 may distribute portions of the structure and/or operations for one or more of AP 102 and STAs 104a-104d of FIG. 1, storage medium 760, and logic circuit 728 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems.

An analog front end (AFE)/radio interface 710 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the configurations are not limited to any specific over-the-air interface or modulation scheme. AFE/Radio interface 710 may include, for example, a receiver 712, a frequency synthesizer 714, and/or a transmitter 716. AFE/Radio interface 710 may include bias controls, a crystal oscillator, and/or one or more antennas 718-f In additional or alternative configurations, the AFE/Radio interface 710 may use external voltage-controlled oscillators (VCOs), surface acoustic wave filters, intermediate frequency (IF) filters and/or RF filters, as desired.

Baseband circuitry 720 may communicate with AFE/Radio interface 710 to process, receive, and/or transmit signals and may include, for example, an analog-to-digital converter 722 for down converting received signals, a digital-to-analog converter 724 for up converting signals for transmission. Further, baseband circuitry 720 may include a baseband or physical layer (PHY) processing circuit 726 for the PHY link layer processing of respective receive/transmit signals. Baseband circuitry 720 may include, for example, a medium access control (MAC) processing circuit 727 for MAC/data link layer processing. Baseband circuitry 720 may include a memory controller 732 for communicating with MAC processing circuit 727 and/or a computing platform 730, for example, via one or more interfaces 734.

In some configurations, PHY processing circuit 726 may include a frame construction and/or detection module, in combination with additional circuitry such as a buffer memory, to construct and/or deconstruct communication frames. Alternatively, or in addition, MAC processing circuit 727 may share processing for certain of these functions or perform these processes independent of PHY processing circuit 726. In some configurations, MAC and PHY processing may be integrated into a single circuit.

The computing platform 730 may provide computing functionality for the device 700. As shown, the computing platform 730 may include a processing component 740. In addition to, or alternatively of, the baseband circuitry 720, the device 700 may execute processing operations or logic for one or more of AP 102 and STAs 104a-104d, storage medium 760, and logic circuit 728 using the processing component 740. The processing component 740 (and/or PHY 726 and/or MAC 727) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 730 may further include other platform components 750. Other platform components 750 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units 760 may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 700 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 700 described herein, may be included or omitted in various embodiments of device 700, as suitably desired.

Embodiments of device 700 may be implemented using single input single output (SISO) architectures. However, certain implementations may include multiple antennas (e.g., antennas 718a-f) for transmission and/or reception using adaptive antenna techniques for beamforming or spatial division multiple access (SDMA) and/or using MIMO communication techniques.

The components and features of device 700 may be implemented using any combination of discrete circuitry, application specific integrated circuits (ASICs), logic gates and/or single chip architectures. Further, the features of device 700 may be implemented using microcontrollers, programmable logic arrays and/or microprocessors or any combination of the foregoing where suitably appropriate. It is noted that hardware, firmware, and/or software elements may be collectively or individually referred to herein as “logic,” “circuit,” or “processor.”

The device in FIG. 7 can also contain a security module (not shown). This security module can contain information regarding, but not limited to, security parameters required to connect the device to another device or other available networks or network devices, and can include WEP or WPA security access keys, network keys, etc., as discussed.

Another module that the device in FIG. 7 can include is a network access unit (not shown). The network access unit can be used for connecting with another network device. In one example, connectivity can include synchronization between devices. In another example, the network access unit can work as a medium which provides support for communication with other stations. In yet another example, the network access unit can work in conjunction with at least the MAC circuitry 727. The network access unit can also work and interact with one or more of the modules/components described herein.

It should be appreciated that the exemplary device 700 shown in the block diagram of FIG. 7 may represent one functionally descriptive example of many potential implementations. Accordingly, division, omission, or inclusion of block functions depicted in the accompanying figures does not infer that the hardware components, circuits, software and/or elements for implementing these functions would be necessarily to be divided, omitted, or included in embodiments.

### Definitions

As used herein, Internet of Things (IoT) or the like can mean a network of physical devices, vehicles, buildings, and/or other objects that can include embedded electronics, software, sensors, and/or network connectivity that enables these objects to collect and exchange data.

As used herein, Resource Unit (RU) can mean any pre-defined block of sub-carriers in an uplink symbol.

As used herein, Out of Band (OoB) can mean any portion of a signal that falls immediately outside the desired bandwidth resulting from the modulation process.

As used herein, Fast Fourier Transform (FFT) can mean an algorithm or a device, software, hardware, etc. that computes the discrete Fourier transform (DFT) of a sequence of signals or values. FFT can convert a sequence of signals from their original domain (often time domain) to a representation in the frequency domain.

As used herein, Inverse FFT (IFFT) can mean can mean an algorithm or a device, software, hardware, etc. that computes the inverse of the FFT of a sequence of signals or values. The IFFT can convert a sequence of signals from their original domain (often frequency domain) to a representation in the time domain

As used herein, N-IFFT can mean an IFFT with a factor of N.

As used herein, Guard Interval (GI) can mean any set of samples, symbols, etc. that can ensure that distinct transmissions do not interfere with one another. A guard interval is general provided between consecutive transmissions to introduce immunity to propagation delays, echoes, and reflections, to which digital data is normally very sensitive.

As used herein, Cyclic Prefix (CP) can mean the prefixing of a symbol with a repetition of a portion of the end of the symbol. Cyclic prefix can function as a guard interval, which can eliminate the intersymbol interference (ISI) from the previous symbol. Further, the CP can, as a repetition of the end of the symbol, allow the linear convolution of a frequency-selective multipath channel to be modelled as circular convolution, which in turn may be transformed to the frequency domain using a Fourier transform. This approach allows for simple frequency-domain processing, such as channel estimation and equalization.

As used herein, Universal Filter (UF) can mean any device, component, hardware, etc. that can filter one or more consecutive subcarriers to eliminate or reduce the effect of sidelobe interference on adjacent subchannels.

As used herein, Orthogonal Frequency Division Multiplex(ing) (OFDM) can mean a frequency-division multiplexing (FDM) scheme used as a digital multi-carrier modulation method. A large number of closely spaced orthogonal sub-carrier signals can be used to carry data on several parallel data streams or channels.

As used herein, UF OFDM can mean any method of encoding digital data on multiple carrier frequencies. OFDM can be a type of frequency-division multiplexing (FDM) scheme used as a digital multi-carrier modulation method. In the method, a large number of closely spaced orthogonal sub-carrier signals can be used to carry data on several parallel data streams or channels. Each sub-carrier may be modulated with a conventional modulation scheme (such as quadrature amplitude modulation or phase-shift keying) at a low symbol rate, maintaining total data rates similar to conventional single-carrier modulation schemes in the same bandwidth.

As used herein, Serial-to-parallel (S/P) can mean any device, component, hardware, etc. that can convert between serial data and parallel interfaces in at least one direction.

As used herein, Parallel-to-serial (P/S) can mean any device, component, hardware, etc. that can convert between parallel interfaces to serial data.

As used herein, Station (STA) can mean any device, such as an IoT sensor, that has the capability to use the 802.11 protocol.

As used herein, Frequency Domain Equalization (FDE) can mean any device or operation that compensates for channel distortion in the frequency domain.

As used herein, Symbol can mean any representation of digital data.

As used herein, Uplink (UL) can mean the portion of the link used to transmit from the STA to an AP or another STA.

As used herein, Downlink (DL) can mean the portion of the link used to transmit from the AP to a STA.

As used herein, Discrete Fourier Transform (DFT) can mean any algorithm or device, hardware that employs the algorithm to convert a finite sequence of equally spaced samples of a function into the list of coefficients of a finite combination of complex sinusoids, ordered by their frequencies, that has those same sample values.

Exemplary aspects are directed toward:

A first wireless device that transmits using a orthogonal frequency division multiplexing access (OFDMA) structure defined by the 802.11ax standard, the first wireless device comprising:

a local oscillator;

transmit circuitry configured to:
generate a signal for transmission on a resource unit (RU) frequency block as defined by the 802.11ax standard;
add a guard interval to a symbol in the signal; and
block transmit filter the signal based on the RU bandwidth of the OFDMA structure, as defined by the 802.11ax standard.

Any one or more of the above aspects, wherein the guard interval is a cyclic prefix (CP).

Any one or more of the above aspects, wherein the block filter reduces out of band (OOB) interference associated with the signal.

Any one or more of the above aspects, wherein the total generated symbol length includes the CP and the additional samples due to filtering.

Any one or more of the above aspects, wherein the transmit circuitry comprises:

a CP adder to add a CP to a symbol in the signal as the guard interval; and

a transmit block filter to block filter the signal.

Any one or more of the above aspects, wherein the transmit circuitry further comprises: a serial-to-parallel converter that converts serial data inbound into the transmit circuitry into two or more parallel data interfaces.

Any one or more of the above aspects, wherein the transmit circuitry further comprises: an Inverse Fast Fourier Transform (IFFT) component that converts a sequence of the two or more parallel data interfaces into the time domain.

Any one or more of the above aspects, wherein the transmit circuitry further comprises: a parallel-to-serial converter that converts the converted parallel data from the IFFT into serial data that is provided to the CP adder.

A system on chip that transmits using a orthogonal frequency division multiplexing access (OFDMA) structure defined by the 802.11ax standard, the system on chip comprising circuitry, wherein the circuitry comprises:

a local oscillator;

transmit circuitry configured to:
generate a signal for transmission on a resource unit (RU) frequency block as defined by the 802.11ax standard;
add a guard interval to a symbol in the signal; and
block transmit filter the signal based on the RU bandwidth of the OFDMA structure, as defined by the 802.11ax standard.

Any one or more of the above aspects, wherein the guard interval is a cyclic prefix (CP).

Any one or more of the above aspects, wherein the block filter reduces out of band (OOB) interference associated with the signal.

Any one or more of the above aspects, wherein the total generated symbol length includes the CP and the additional samples due to filtering.

Any one or more of the above aspects, wherein the transmit circuitry comprises:

a CP adder to add a CP to a symbol in the signal as the guard interval; and

a transmit block filter to block filter the signal.

Any one or more of the above aspects, wherein the transmit circuitry further comprises: a serial-to-parallel converter that converts serial data inbound into the transmit circuitry into two or more parallel data interfaces.

Any one or more of the above aspects, wherein the transmit circuitry further comprises: an Inverse Fast Fourier Transform (IFFT) component that converts a sequence of the two or more parallel data interfaces into the time domain.

Any one or more of the above aspects, wherein the transmit circuitry further comprises: a parallel-to-serial converter that converts the converted parallel data from the IFFT into serial data that is provided to the CP adder.

A first wireless device that transmits using a orthogonal frequency division multiplexing access (OFDMA) structure defined by the 802.11ax standard, the first wireless device comprising:

means for providing a local oscillator;

transmit circuitry configured to:
means for generating a signal for transmission on a resource unit (RU) frequency block as defined by the 802.11ax standard;
means for adding a guard interval to a symbol in the signal; and
means for block transmit filtering the signal based on the RU bandwidth of the OFDMA structure, as defined by the 802.11ax standard.

Any one or more of the above aspects, wherein the guard interval is a cyclic prefix (CP).

Any one or more of the above aspects, wherein the block filter reduces out of band (OOB) interference associated with the signal.

Any one or more of the above aspects, wherein the total generated symbol length includes the CP and the additional samples due to filtering.

Any one or more of the above aspects, wherein the transmit circuitry comprises:

means for adding a CP to a symbol in the signal as the guard interval; and

means for transmit block filtering to block filter the signal.

Any one or more of the above aspects, wherein the transmit circuitry further comprises: means for converting serial data inbound into the transmit circuitry into two or more parallel data interfaces.

Any one or more of the above aspects, wherein the transmit circuitry further comprises: means for converting a sequence of the two or more parallel data interfaces into the time domain.

Any one or more of the above aspects, wherein the transmit circuitry further comprises: means for converting the converted parallel data from the IFFT into serial data that is provided to the CP adder.

A method performed by a wireless device, the method comprising:

receiving data comprising two or more symbols;

mapping the data to a 802.11ax resource unit (RU) size;

performing an Inverse Fast Fourier Transform (IFFT) on the data;

adding a guard interval to each of the two or more symbols; and

block filtering the data based on a bandwidth associated with a resource unit (RU) of a orthogonal frequency division multiplexing access (OFDMA) structure, as defined by the 802.11ax standard, used by the wireless device for transmission of data.

Any one or more of the above aspects, wherein the data is serial data, and the method further comprises converting the serial data into two or more parallel data interfaces.

Any one or more of the above aspects, wherein the parallel data is transformed from the frequency domain to the time domain with the Inverse Fast Fourier Transform (IFFT).

Any one or more of the above aspects, further comprising:

converting the parallel data from the IFFT to serial data;

providing the serial data to a CP adder;

the CP adder adding a CP to each of the two or more blocks of data as the guard interval; and

the CP adder providing the converted data to a CP adder to add a CP as the guard interval.

A non-transitory computer-readable storage media that stores instructions for execution by one or more processors to perform a method comprising:

instructions to receive data comprising two or more symbols;

instructions to map the data to a 802.11ax resource unit (RU) size;

instructions to perform an Inverse Fast Fourier Transform (IFFT) on the data;

instructions to add a guard interval to each of the two or more symbols; and

instructions to block filter the data based on a bandwidth associated with a resource unit (RU) of a orthogonal frequency division multiplexing access (OFDMA) structure, as defined by the 802.11ax standard, used by the wireless device for transmission of data.

Any one or more of the above aspects, wherein the guard interval is a cyclic prefix (CP) removed from the beginning of the symbol.

Any one or more of the above aspects, wherein the signal has reduced out of band (OOB) interference associated with the signal.

Any one or more of the above aspects, wherein the receive circuitry comprises: a window and CP removal component to window the signal and remove the guard interval.

Any one or more of the above aspects, wherein the receive circuitry further comprises: a serial-to-parallel converter that converts serial data from the window and CP removal component into two or more parallel data interfaces according to a size of the RU of a 802.11ax OFDMA structure.

Any one or more of the above aspects, wherein the receive circuitry further comprises: a Fast Fourier Transform (FFT) component that converts a sequence of the two or more parallel data interfaces into the frequency domain.

Any one or more of the above aspects, wherein the receive circuitry further comprises: a frequency domain equalization (FDE) component that compensates for channel distortion on the converted data from the FFT.

Any one or more of the above aspects, wherein the receive circuitry further comprises: a parallel-to-serial converter that converts the parallel data from the FDE component into serial data.

A system on chip that receives signals based on an orthogonal frequency division multiplexing access (OFDMA) structure defined by the 802.11ax standard, the system on chip comprising:

receive circuitry configured to:
receive a signal from a transmitting device, wherein the signal has been block transmit filtered based on a resource unit (RU) bandwidth of the OFDMA structure, as defined by the 802.11ax standard used by the transmitting device and has been modified; and
window the received signal;
remove a guard interval inserted into the received signal; and
ingest data in the signal.

Any one or more of the above aspects, wherein the guard interval is a cyclic prefix (CP) removed from the beginning of the symbol.

Any one or more of the above aspects, wherein the signal has reduced out of band (OOB) interference associated with the signal.

Any one or more of the above aspects, wherein the receive circuitry comprises: a window and CP removal component to window the signal and remove the guard interval.

Any one or more of the above aspects, wherein the receive circuitry further comprises: a serial-to-parallel converter that converts serial data from the window and CP removal component into two or more parallel data interfaces according to a size of the RU of a 802.11ax OFDMA structure.

Any one or more of the above aspects, wherein the receive circuitry further comprises: a Fast Fourier Transform (FFT) component that converts a sequence of the two or more parallel data interfaces into the frequency domain.

Any one or more of the above aspects, wherein the receive circuitry further comprises: a frequency domain equalization (FDE) component that compensates for channel distortion on the converted data from the FFT.

Any one or more of the above aspects, wherein the receive circuitry further comprises: a parallel-to-serial converter that converts the parallel data from the FDE component into serial data.

A receiving wireless device that receives signals based on an orthogonal frequency division multiplexing access (OFDMA) structure defined by the 802.11ax standard, the receiving wireless device comprising:

receive circuitry configured to:
means for receiving a signal from a transmitting device, wherein the signal has been block transmit filtered based on a resource unit (RU) bandwidth of the OFDMA structure, as defined by the 802.11ax standard used by the transmitting device and has been modified; and
means for windowing the received signal;
means for removing a guard interval inserted into the received signal; and
means for ingesting data in the signal.

Any one or more of the above aspects, wherein the guard interval is a cyclic prefix (CP) removed from the beginning of the symbol.

Any one or more of the above aspects, wherein the signal has reduced out of band (OOB) interference associated with the signal.

Any one or more of the above aspects, wherein the receive circuitry comprises: means for windowing the signal and removing the guard interval.

Any one or more of the above aspects, wherein the receive circuitry further comprises: means for converting serial data from the window and CP removal component into two or more parallel data interfaces according to a size of the RU of a 802.11ax OFDMA structure.

Any one or more of the above aspects, wherein the receive circuitry further comprises: means for converting a sequence of the two or more parallel data interfaces into the frequency domain.

Any one or more of the above aspects, wherein the receive circuitry further comprises: means for compensating for channel distortion on the converted data from the FFT.

Any one or more of the above aspects, wherein the receive circuitry further comprises: means for converting the parallel data from the FDE component into serial data.

A method performed by a wireless receiving device, the method comprising: receiving a signal from a transmitting device, wherein the signal has been block transmit filtered based on a resource unit (RU) bandwidth of the OFDMA structure, as defined by the 802.11ax standard used by the transmitting device and has been modified; and

windowing the received signal;

removing a guard interval inserted into the received signal; and

ingesting data in the signal.

Any one or more of the above aspects, wherein the guard interval is a cyclic prefix (CP) removed from the beginning of the symbol.

Any one or more of the above aspects, wherein the signal has reduced out of band (OOB) interference associated with the signal.

Any one or more of the above aspects, further comprising

windowing the signal; and

removing the guard interval.

Any one or more of the above aspects, further comprising converting serial data from the window and CP removal component into two or more parallel data interfaces according to a size of the RU of a 802.11ax OFDMA structure.

Any one or more of the above aspects, further comprising converting a sequence of the two or more parallel data interfaces into the frequency domain.

Any one or more of the above aspects, further comprising compensating for channel distortion on the converted data from the FFT.

Any one or more of the above aspects, further comprising converting the parallel data from the FDE component into serial data.

A wireless receiving device comprising:

means for receiving a signal from a transmitting device, wherein the signal has been block transmit filtered based on a resource unit (RU) bandwidth of the OFDMA structure, as defined by the 802.11ax standard used by the transmitting device and has been modified; and

means for windowing the received signal;

means for removing a guard interval inserted into the received signal; and

means for ingesting data in the signal.

Any one or more of the above aspects, wherein the guard interval is a cyclic prefix (CP) removed from the beginning of the symbol.

Any one or more of the above aspects, wherein the signal has reduced out of band (OOB) interference associated with the signal.

Any one or more of the above aspects, further comprising

means for windowing the signal; and

means for removing the guard interval.

Any one or more of the above aspects, further comprising means for converting serial data from the window and CP removal component into two or more parallel data interfaces according to a size of the RU of a 802.11ax OFDMA structure.

Any one or more of the above aspects, further comprising means for converting a sequence of the two or more parallel data interfaces into the frequency domain.

Any one or more of the above aspects, further comprising means for compensating for channel distortion on the converted data from the FFT.

Any one or more of the above aspects, further comprising means for converting the parallel data from the FDE component into serial data.

For purposes of explanation, numerous details are set forth in order to provide a thorough understanding of the present embodiments. It should be appreciated however that the techniques herein may be practiced in a variety of ways beyond the specific details set forth herein.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, WiFi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Provided herein are exemplary systems and methods for full- or half-duplex communications in a wireless device(s). While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless device that transmits using an orthogonal frequency division multiplexing access (OFDMA) structure defined by the IEEE 802.11ax standard, the wireless device comprising:
a local oscillator;
transmit circuitry configured to:
generate a signal for transmission on a resource unit (RU) frequency block as defined by the 802.11ax standard;
add a guard interval to a symbol in the signal; and
block transmit filter the signal based on the RU bandwidth of the OFDMA structure, as defined by the IEEE 802.11ax standard.

2. The wireless device of claim 1, wherein the guard interval is a cyclic prefix (CP).

3. The wireless device of claim 1, wherein the block filter reduces out of band (OOB) interference associated with the signal.

4. The wireless device of claim 1, wherein the total generated symbol length includes the CP and the additional samples due to filtering.

5. The wireless device of claim 1, wherein the transmit circuitry comprises:
a CP adder to add a CP to a symbol in the signal as the guard interval; and
a transmit block filter to block filter the signal.

6. The wireless device of claim 5, wherein the transmit circuitry further comprises: a serial-to-parallel converter that converts serial data inbound into the transmit circuitry into two or more parallel data interfaces.

7. The wireless device of claim 6, wherein the transmit circuitry further comprises: an Inverse Fast Fourier Transform (IFFT) component that converts a sequence of the two or more parallel data interfaces into the time domain.

8. The wireless device of claim 7, wherein the transmit circuitry further comprises: a parallel-to-serial converter that converts the converted parallel data from the IFFT into serial data that is provided to the CP adder.

9. A receiving wireless device that receives signals based on an orthogonal frequency division multiplexing access (OFDMA) structure defined by the 802.11ax standard, the receiving wireless device comprising:
receive circuitry configured to:
receive a signal from a transmitting device, wherein the signal has been block transmit filtered based on a resource unit (RU) bandwidth of the OFDMA structure, as defined by the IEEE 802.11ax standard used by the transmitting device and has been modified; and
window the received signal;
remove a guard interval inserted into the received signal; and
ingest data in the signal.

10. The receiving wireless device of claim 9, wherein the guard interval is a cyclic prefix (CP) removed from the beginning of the symbol.

11. The receiving wireless device of claim 9, wherein the signal has reduced out of band (OOB) interference associated with the signal.

12. The receiving wireless device of claim 9, wherein the receive circuitry comprises: a window and CP removal component to window the signal and remove the guard interval.

13. The receiving wireless device of claim 12, wherein the receive circuitry further comprises: a serial-to-parallel converter that converts serial data from the window and CP removal component into two or more parallel data interfaces according to a size of the RU of a 802.11ax OFDMA structure.

14. The receiving wireless device of claim 13, wherein the receive circuitry further comprises: a Fast Fourier Transform (FFT) component that converts a sequence of the two or more parallel data interfaces into the frequency domain.

15. The receiving wireless device of claim 14, wherein the receive circuitry further comprises: a frequency domain equalization (FDE) component that compensates for channel distortion on the converted data from the FFT.

16. The receiving wireless device of claim 15, wherein the receive circuitry further comprises: a parallel-to-serial converter that converts the parallel data from the FDE component into serial data.

17. A method performed by a wireless device, the method comprising:
receiving data comprising two or more symbols;
mapping the data to a IEEE 802.11ax resource unit (RU) size;
performing an Inverse Fast Fourier Transform (IFFT) on the data;
adding a guard interval to each of the two or more symbols; and
block filtering the data based on a bandwidth associated with a resource unit (RU) of a orthogonal frequency division multiplexing access (OFDMA) structure, as defined by the IEEE 802.11ax standard, used by the wireless device for transmission of data.

18. The method of claim 17, wherein the data is serial data, and the method further comprises converting the serial data into two or more parallel data interfaces.

19. The method of claim 18, wherein the parallel data is transformed from the frequency domain to the time domain with the Inverse Fast Fourier Transform (IFFT).

20. The method of claim 19, further comprising:
converting the parallel data from the IFFT to serial data;
providing the serial data to a CP adder;
the CP adder adding a CP to each of the two or more blocks of data as the guard interval; and
the CP adder providing the converted data to a CP adder to add a CP as the guard interval.
